(19) United States
(12) Patent Application Publication
(10) Pub. No.: US 2026/0355928 A1
(43) Pub. Date: Nov. 12, 2026

(54) ADAPTABLE ATTACHMENT AND STORAGE SYSTEMS AND THEIR METHODS OF USE AND PRODUCTION

(71) Applicants: Bryce Brunsting, Irvine, CA (US); Bryan Brunsting, Irvine, CA (US)

(72) Inventors: Bryce Brunsting, Irvine, CA (US); Bryan Brunsting, Irvine, CA (US)

(21) Appl. No.: 19/640,186

(22) Filed: Apr. 6, 2026

Related U.S. Application Data
(60) Provisional application No. 63/783,694, filed on Apr. 4, 2025.

(51) Int. Cl. B25H 3/02

(52) U.S. Cl. CPC B25H 3/021

(57) ABSTRACT

To address the need for a better solution with respect to storage boxes, heavy-duty storage boxes, crates, and rolling carts, an adaptable and removeable attachment and storage system has been developed that is flexible, strong, adaptable to different size storage boxes and crates, easily attached to and removed from storage boxes and crates without the use of tools, and able to hold any number and sizes of tools.

This United States utility patent application claims priority to United States Provisional Patent Application Serial No.: 63/783,694, which was filed on Apr. 4, 2025, is commonly-owned, and is incorporated herein in its entirety by reference.

### FIELD OF THE SUBJECT MATTER

The field of the subject matter is adaptable and removable attachment and storage systems and their methods of use and production.

### BACKGROUND

Modular, stackable, and interchangeable storage systems that are able to be easily moved and stored are gaining popularity with trade professionals, do-it-yourselfers (“DIYers”) and hobbyists, along with weekend warriors who want a better way to organize tools and supplies for the job site, home improvement projects, hobbies and other projects around the home. One of the most popular systems of this type is the Milwaukee Packout System that allows the user to fully customize his or her storage system that can be either stationary or easily movable/relocatable.

US Patent Publication No.: 20230122425 utilizes a number of Modular Lightweight Load-Carrying Equipment (MOLLE) systems internally and a MOLLE-like board externally to provide additional and accessible storage space to the inside and outside of connectable, heavy-duty storage boxes, crates, rolling carts and/or dollies. And while the internal systems are able to be located throughout the inside of the storage space, the external board (Reference No.: 482) is solid and affixed to the outside of the storage box by using a nut and bolt arrangement. This solid board arrangement that is connected to the storage box using nuts and bolts requires the user to have additional tools available to remove the MOLLE-like board. In addition, these MOLLE-like boards are not flexible and necessarily adaptable. Finally, the MOLLE-like boards in this reference are sized to fit a particular part of the storage box and are not relocatable onto another differently-sized storage box (one that may be smaller/larger, have wheels in different locations, etc).

Ideally and to address the need for a better solution with respect to storage boxes, heavy-duty storage boxes, crates, and rolling carts, an adaptable and removeable attachment and storage system should be developed that is flexible, strong, adaptable to different size storage boxes and crates, easily attached to and removed from storage boxes and crates without the use of tools, and able to hold any number and sizes of tools —whether it is attached to a storage box or on its own.

### BRIEF SUMMARY OF THE SUBJECT MATTER

A removable storage system is disclosed herein comprising: a flexible base substrate, at least one coupling system that is secured to the flexible base substrate, wherein the coupling system is designed to be attached to and removed from a separate storage cabinet, and at least one linear attachment component that comprises at least one expandable and retractable band, wherein the linear attachment component is stationarily coupled with the flexible base substrate.

Another contemplated removable storage system is disclosed herein, comprising: a flexible base substrate, at least one coupling system that is secured to the flexible base substrate, wherein the coupling system is designed to be attached to and removed from a separate storage cabinet, and least one linear attachment component that comprises at least one expandable and retractable band, wherein the linear attachment component is removably coupled with the flexible base substrate.

A tool and supply storage system is described herein comprising: any one or more of the contemplated removable storage systems, and a storage cabinet, wherein the storage cabinet comprises at least one attachment point for removably attaching the removable storage system.

### BRIEF DESCRIPTION OF THE FIGURES

FIG. 1 shows a removable storage system 100 comprising: a flexible base substrate 110, at least one coupling system that is secured to the flexible base substrate 120, wherein the coupling system is designed to be attached to and removed from a separate storage cabinet, and at least one linear attachment component 130 that comprises at least one expandable and retractable band 140, wherein the linear attachment component is stationarily coupled with the flexible base substrate. Also shown in FIG. 1, a tool and supply storage system 150 is described herein comprising: any one or more of the contemplated removable storage systems 100, and a storage cabinet 160, wherein the storage cabinet comprises at least one attachment point 170 for removably attaching the removable storage system 100.

FIG. 2 shows a contemplated example of a separate storage cabinet that includes at least one attachment point for removably attaching the removable storage system.

FIG. 3 shows a contemplated example of a separate storage cabinet that includes at least one attachment point for removably attaching the removable storage system.

FIG. 4 shows a contemplated example of a separate storage cabinet that includes at least one attachment point for removably attaching the removable storage system.

FIG. 5 shows a contemplated example of a separate storage cabinet that includes at least one attachment point for removably attaching the removable storage system.

FIG. 6 shows the removable storage system of FIG. 1 as a close up view 600. Also shown in FIG. 6, a tool and supply storage system 650 is described herein comprising: any one or more of the contemplated removable storage systems 600, and a storage cabinet 660, wherein the storage cabinet comprises at least one attachment point 670 for removably attaching the removable storage system 600.

FIG. 7 shows the same contemplated embodiment as shown in FIGS. 1 and 6 before being removably coupled or attached to the external support structure. Also shown in FIG. 7, a tool and supply storage system 750 is described herein comprising: any one or more of the contemplated removable storage systems 700, and a storage cabinet 760, wherein the storage cabinet comprises at least one attachment point 770 for removably attaching the removable storage system 700.

FIG. 8 shows the same perspective view with the contemplated storage system removably coupled or attached to the Milwaukee Packout System. Also shown in FIG. 8, a tool and supply storage system 850 is described herein comprising: any one or more of the contemplated removable storage systems 800, and a storage cabinet 860, wherein the storage cabinet comprises at least one attachment point 870 for removably attaching the removable storage system 800.

FIG. 9 shows the same perspective view with the contemplated storage system in the process of being fully coupled or attached to the Milwaukee Packout System. Also shown in FIG. 9, a tool and supply storage system 950 is described herein comprising: any one or more of the contemplated removable storage systems 900, and a storage cabinet 960, wherein the storage cabinet comprises at least one attachment point 970 for removably attaching the removable storage system 900.

FIG. 10 shows a removable storage system 1000 comprising: a flexible base substrate 1010, at least one coupling system 1020 that is secured to the flexible base substrate 1010, wherein the coupling system is designed to be attached to and removed from a separate storage cabinet (not shown in this Figure), and at least one linear attachment component that comprises at least one expandable and retractable band (not shown in this Figure), wherein the linear attachment component is stationarily coupled with the flexible base substrate.

FIG. 11 shows a removable storage system 1100 comprising: a flexible base substrate 1110, at least one coupling system 1120 that is secured to the flexible base substrate, wherein the coupling system is designed to be attached to and removed from a separate storage cabinet (not shown in this Figure), and at least one linear attachment component that comprises at least one expandable and retractable band 1140, wherein the linear attachment component is stationarily coupled with the flexible base substrate.

FIG. 12 shows another contemplated removable storage system comprising: a flexible base substrate 1210, at least one coupling system 1220 that is secured to the flexible base substrate, wherein the coupling system is designed to be attached to and removed from a separate storage cabinet (not shown in this Figure), and least one linear attachment component 1230 that comprises at least one expandable and retractable band 1240, wherein the linear attachment component is removably coupled, as shown by reference 1235, with the flexible base substrate 1210. The dotted line at 1235 represents the connection point or layer where the linear attachment component is removably coupled with the flexible base substrate.

FIG. 13 shows a contemplated removable storage system 1300 that is disclosed herein, wherein at least one tool 1380 is being held in place by the at least one expandable and retractable band 1340 on the at least one linear attachment component 1330.

FIG. 14 shows a contemplated removable storage system 1400 that is disclosed herein, wherein at least one tool 1480 is being held in place by the at least one expandable and retractable band 1440 on the at least one linear attachment component 1430.

### DETAILED DESCRIPTION

To address the need for a better solution with respect to storage boxes, heavy-duty storage boxes, crates, and rolling carts, an adaptable and removeable attachment and storage system has been developed that is flexible, strong, adaptable to different size storage boxes, rolling carts and crates, easily attached to and removed from storage boxes and crates without the use of tools, and able to hold any number and sizes of tools-whether it is attached to a storage box or on its own.

A removable storage system is disclosed herein comprising: a flexible base substrate, at least one coupling system that is secured to the flexible base substrate, wherein the coupling system is designed to be attached to and removed from a separate storage cabinet, and at least one linear attachment component that comprises at least one expandable and retractable band, wherein the linear attachment component is stationarily coupled with the flexible base substrate.

Another contemplated removable storage system is disclosed herein, comprising: a flexible base substrate, at least one coupling system that is secured to the flexible base substrate, wherein the coupling system is designed to be attached to and removed from a separate storage cabinet, and least one linear attachment component that comprises at least one expandable and retractable band, wherein the linear attachment component is removably coupled with the flexible base substrate.

A tool and supply storage system is described herein comprising: any one or more of the contemplated removable storage systems, and a storage cabinet, wherein the storage cabinet comprises at least one attachment point for removably attaching the removable storage system.

Contemplated embodiments may also be utilized by crafters and hobbyists to removably secure tools and supplies to a storage box, rolling cart, craft compartment, or a similar item. Contemplated tools or implements that can be secured include power tools, analog tools, such as wrenches or hammers, scissors, knitting or crochet needles, etc.

Contemplated attachment and storage systems are designed to be safely secured to a storage box or crate, while at the same time easily removable and secured or another storage box or crate without the use of tools or without the use of emptying or clearing out the attachment and storage system that is being moved or relocated. Contemplated attachment and storage systems are also designed to be safely separated from a storage box or crate and kept in tact for a period of time without being attached to a storage box or crate. In other words, the secured tools and implements will stay secured even after removing the attachment and storage system from the storage box or crate.

Contemplated coupling systems may comprise any suitable component or set of components that are designed to secure a removable storage system to a storage cabinet that has at least one attachment point. A contemplated coupling system may comprise at least one male locking component and at least one corresponding female locking component. Another contemplated coupling system may comprise at least one hook and loop-style coupling component. In these embodiments, the at least one hook and loop-style coupling component comprises a Velcro-type coupling component. A contemplated coupling system may comprise slidably engaging locking components.

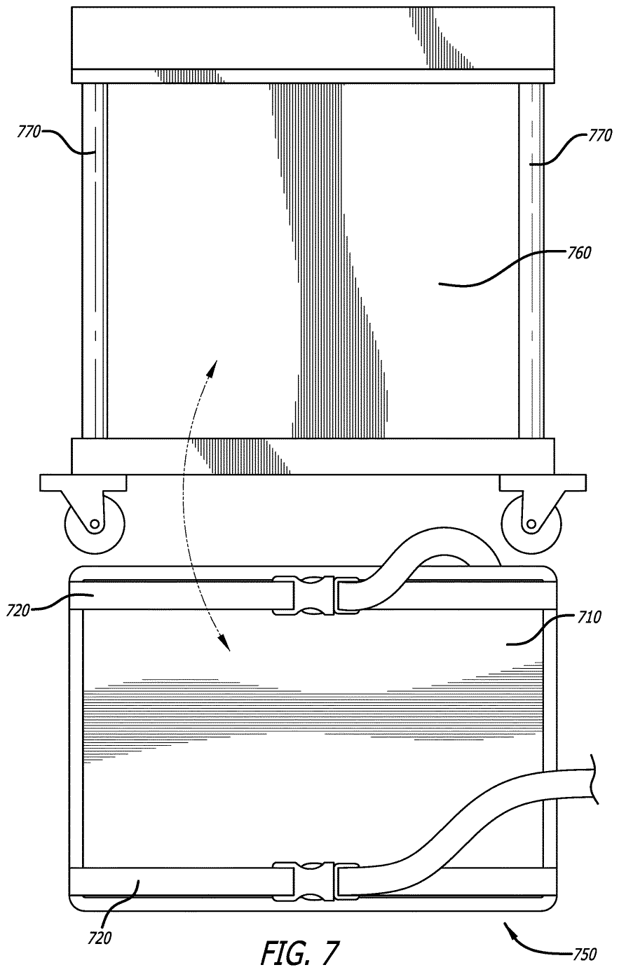

A contemplated coupling or locking system also comprises a tightening mechanism, wherein contemplated embodiments of a storage system can be secured and tightened in place once the connector is engaged around the support poles/attachment points of the storage box or crate. A contemplated coupling system is shown in FIGS. 7, 9, and 10.

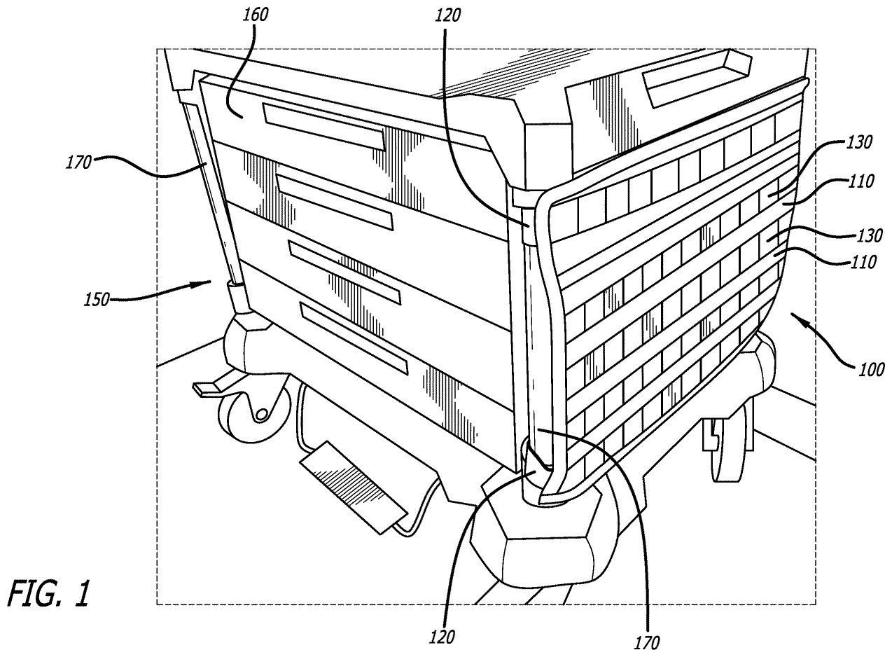

Contemplated adaptable and removable attachment and storage systems can be used with the Milwaukee Packout System and similar storage systems, as shown in FIG. 1. In this Figure, a contemplated system is removably coupled or attached to the external support structure of the Milwaukee Packout System by coupling or attaching the contemplated system to the support poles that are located on the corners of the Milwaukee Packout System. Specifically in FIG. 1, a removable storage system 100 is disclosed herein comprising: a flexible base substrate 110, at least one coupling system 120 that is secured to the flexible base substrate, wherein the coupling system is designed to be attached to and removed from a separate storage cabinet, and at least one linear attachment component 130 that comprises at least one expandable and retractable band 140, wherein the linear attachment component is stationarily coupled with the flexible base substrate. Also shown in FIG. 1, a tool and supply storage system 150 is described herein comprising: any one or more of the contemplated removable storage systems 100, and a storage cabinet 160, wherein the storage cabinet comprises at least one attachment point 170 for removably attaching the removable storage system 100.

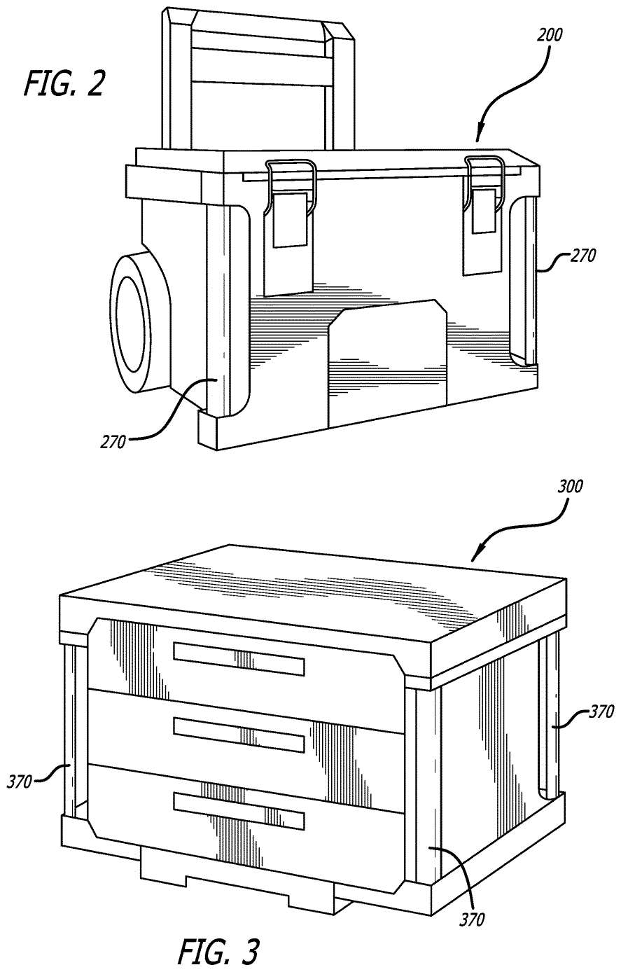

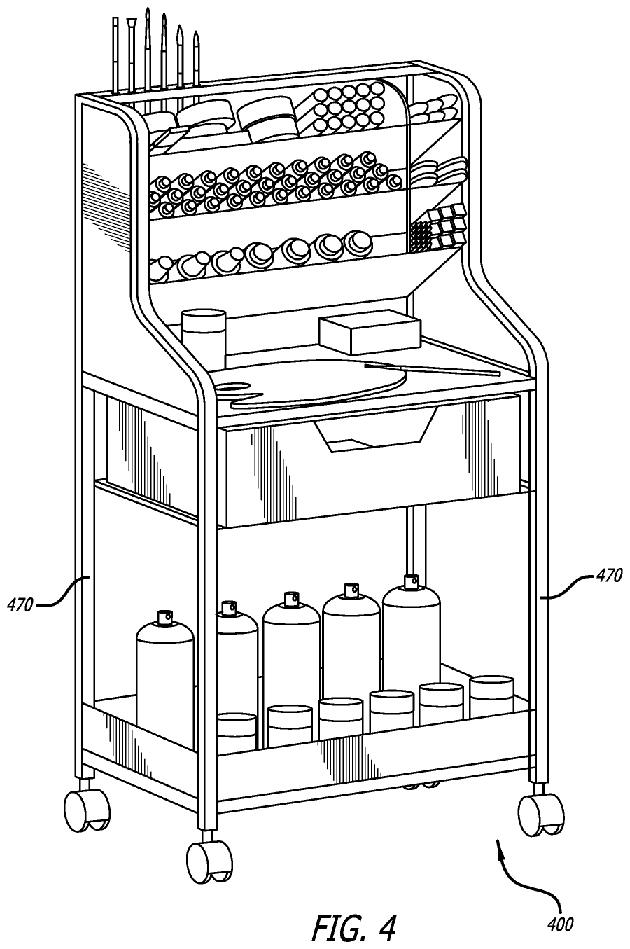

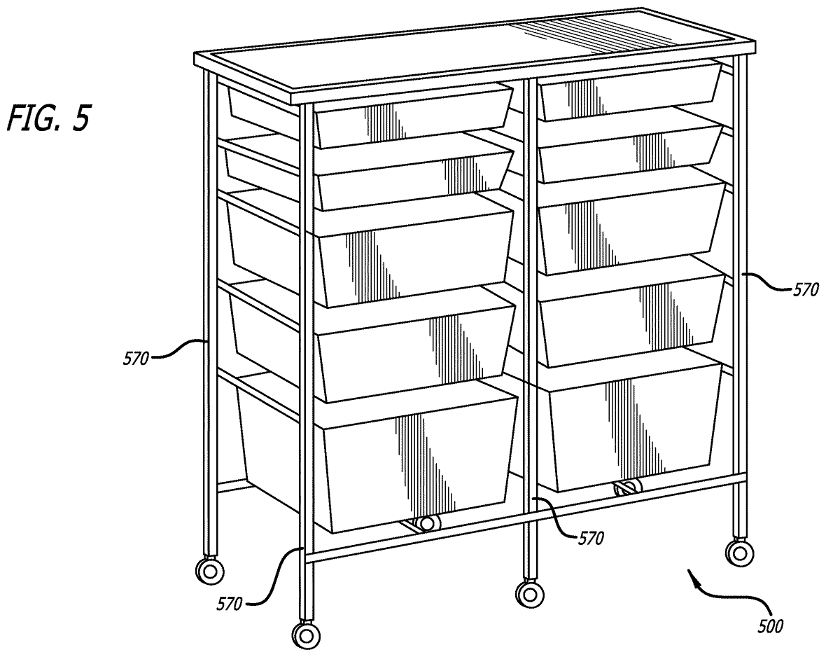

FIGS. 2, 3, 4, and 5 show contemplated examples of a separate storage cabinet (200, 300, 400, and 500 respectively) that includes at least one attachment point (270, 370, 470, and 570 respectively) for removably attaching the removable storage system (not shown in these figures). Contemplated attachment points include any suitable point or points on the storage cabinet that is capable of securing, holding, and/or stabilizing a removable storage system as contemplated herein. In some embodiments, contemplated attachment points include bars, tubes, punchouts, holes, or a combination thereof.

It should be understood from these figures and this description that suitable separate storage cabinets may be designed to hold or contain a number of different items, including tools, craft supplies, makeup and beauty products, computer hardware and supplies, office or school supplies, pet supplies, and any other suitable item that is kept in a storage cabinet that also needs to be accessed by a user at some point.

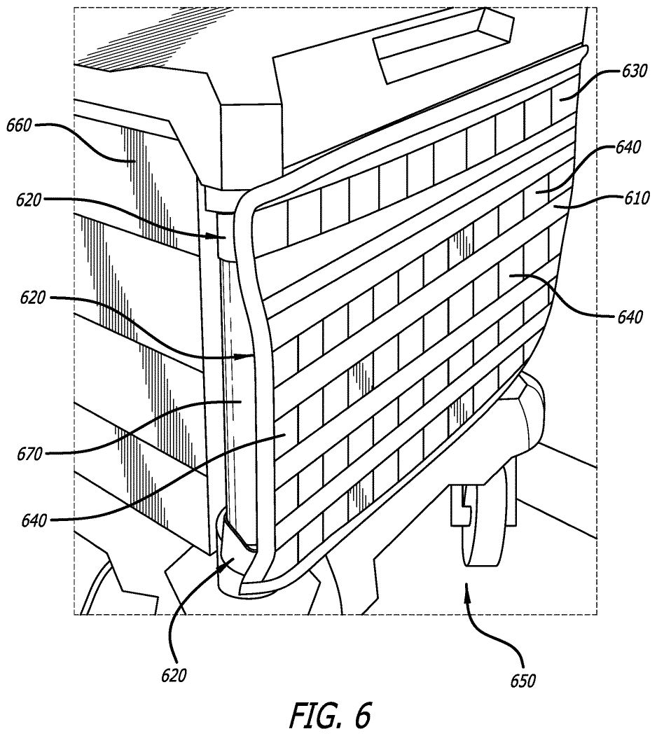

FIG. 6 shows the removable storage system of FIG. 1 as a close up view 600. In this figure, it is easy to see the flexible base substrate 610, the at least one coupling system 620 that is secured to the flexible base substrate 610, wherein the at least one coupling system 620 is designed to be attached to and removed from a separate storage cabinet 660 (not shown in full), and at least one linear attachment component 630 that comprises at least one expandable and retractable band 640, wherein the linear attachment component is stationarily and/or permanently coupled with the flexible base substrate. Also shown in FIG. 6, a tool and supply storage system 650 is described herein comprising: any one or more of the contemplated removable storage systems 600, and a storage cabinet 660, wherein the storage cabinet comprises at least one attachment point 670 for removably attaching the removable storage system 600. In this embodiment, the use of the terms “stationarily” and “permanently” means that the linear attachment component is attached to the flexible base substrate in a way that it is not designed to be removed and repositioned. The linear attachment component may be sewn to, affixed to, adhered to the flexible base substrate in a way that ensures it is stable and in a way that is not designed to be easily removable from the flexible base substrate.

As shown in the Figures, contemplated embodiments comprise a number of flexible and strong expandable and retractable bands where tools can be slid through one or more expandable and retractable bands in order to be held in place and then easily removed from the contemplated storage system. Each of the expandable and retractable bands is securely reinforced to the backing of the contemplated storage system, so that the tools can be held in place, removed, and replaced without damage to the contemplated storage system.

As mentioned, in some contemplated embodiments, there is a flexible base substrate wherein the linear attachment components that include the expandable and retractable bands are securely attached and reinforced to that flexible base substrate. A contemplated flexible base substrate isn't made up of one layer of material, but instead comprises at least two layers of materials, and in some embodiments, at least three layers of material, including an aluminum or similar support structure layer that is stitched within the flexible base substrate.

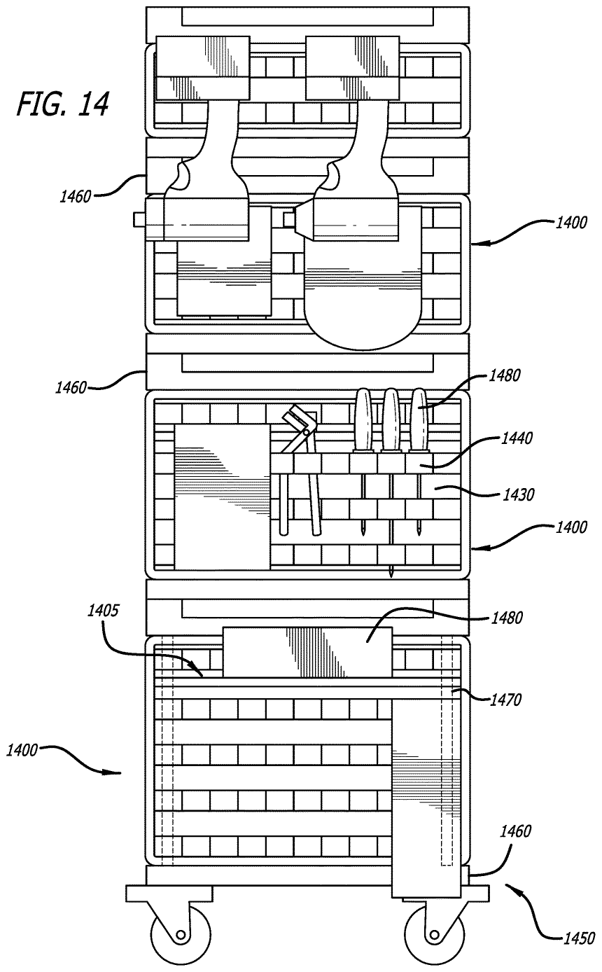

A contemplated flexible base substrate also has a front, where the expandable and retractable bands are, and an exposed back, where the coupling system is attached. In some embodiments, however, a flexible base substrate may also be used to make up a pocket or pouch, wherein the pocket or pouch is located physically behind the linear attachment components. A typical embodiment is shown in FIG. 14, which will be described in detail later.

A contemplated flexible base substrate may comprise a synthetic fabric, a natural fabric, or a combination thereof. In some embodiments, a contemplated flexible base substrate may comprise a polymer. In other embodiments, a contemplated polymer comprises nylon. Contemplated flexible base substrates may also comprise any suitable color or combination of colors. For example, the flexible base substrate may be red and the linear attachment components and/or expandable and retractable bands may be black or dark gray.

A contemplated coupling or locking system comprises a male/female type of connector and a tightening mechanism, wherein contemplated embodiments of a storage system can be secured and tightened in place once the connector is engaged around the support poles of the storage box or crate. In some embodiments, a contemplated attachment, coupling or locking system may be a hook and loop system, including VELCRO or a VELCRO-like material as an example. A contemplated coupling system is shown in FIGS. 7, 9, and 10.

FIG. 7 shows the same contemplated embodiment before being removably coupled or attached to the external support structure. Note that the contemplated embodiment is lying face down, thus showing the attachment system that is used to removably couple or attach a contemplated storage system to the support poles of the Milwaukee Packout System. In FIG. 7, a removable storage system 700 is disclosed herein comprising: a flexible base substrate 710, at least one coupling system 720 that is secured to the flexible base substrate 710, wherein the coupling system is designed to be attached to and removed from a separate storage cabinet, and at least one linear attachment component (not shown in this Figure) that comprises at least one expandable and retractable band (not shown in this Figure), wherein the linear attachment component is stationarily coupled with the flexible base substrate. Also shown in FIG. 7, a tool and supply storage system 750 is described herein comprising: any one or more of the contemplated removable storage systems 700, and a storage cabinet 760, wherein the storage cabinet comprises at least one attachment point 770 for removably attaching the removable storage system 700.

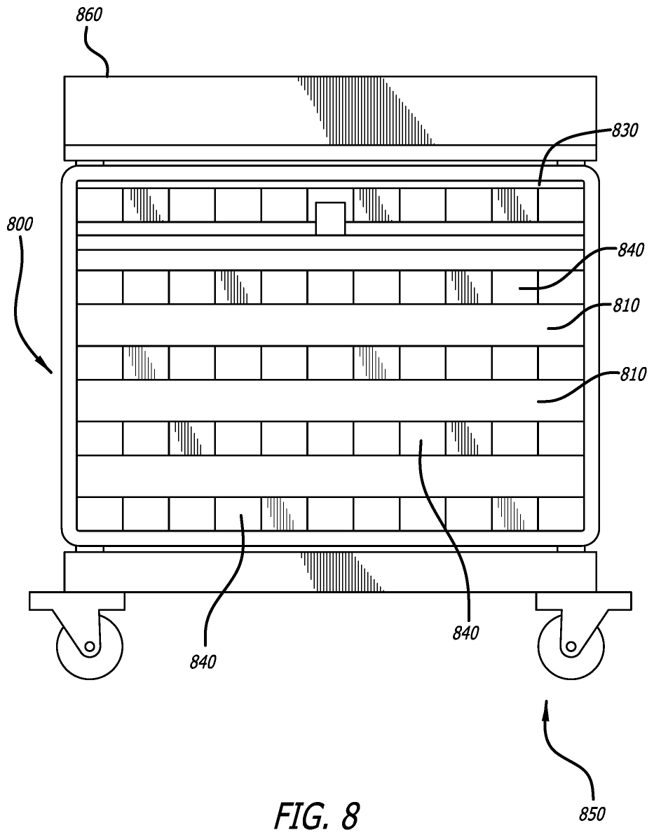

FIG. 8 shows the same perspective view with the contemplated storage system removably coupled or attached to the Milwaukee Packout System. In FIG. 8, a removable storage system 800 is disclosed herein comprising: a flexible base substrate 810, at least one coupling system (not shown in this Figure) that is secured to the flexible base substrate, wherein the coupling system is designed to be attached to and removed from a separate storage cabinet, and at least one linear attachment component 830 that comprises at least one expandable and retractable band 840, wherein the linear attachment component is stationarily coupled with the flexible base substrate. Also shown in FIG. 8, a tool and supply storage system 850 is described herein comprising: any one or more of the contemplated removable storage systems 800, and a storage cabinet 860, wherein the storage cabinet comprises at least one attachment point 870 for removably attaching the removable storage system 800.

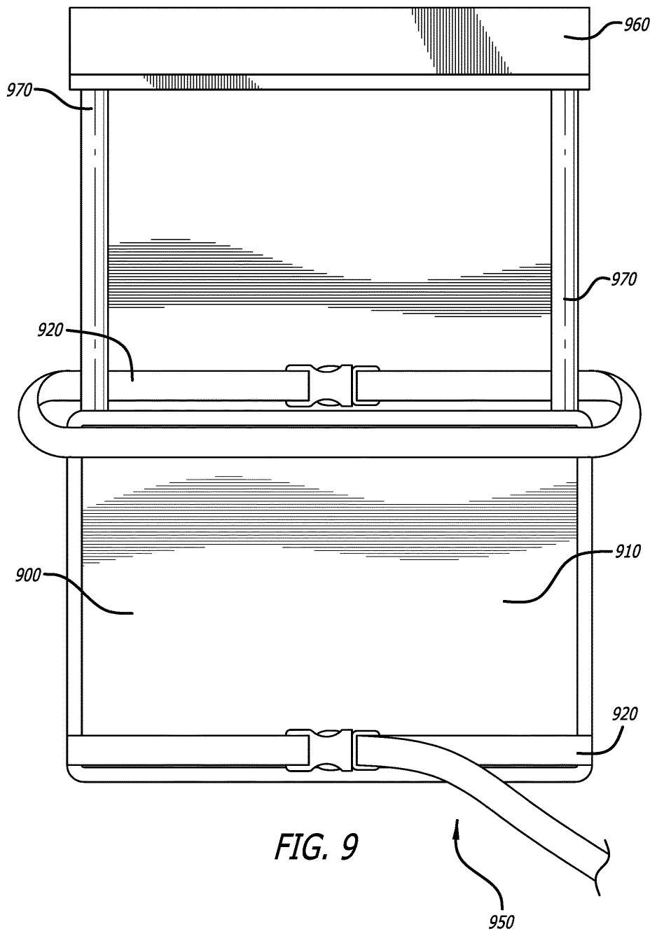

FIG. 9 also shows the same perspective view with the contemplated storage system in the process of being fully coupled or attached to the Milwaukee Packout System. Note that the bottom of the contemplated storage system has been coupled or attached to the support poles through the coupling or attachment system with the top of the contemplated storage system being prepared to also be attached to the top of the support poles. Specifically in FIG. 9, a removable storage system 900 is disclosed herein comprising: a flexible base substrate 910, at least one coupling system 920 that is secured to the flexible base substrate 910, wherein the coupling system is designed to be attached to and removed from a separate storage cabinet, and at least one linear attachment component (not shown in this Figure) that comprises at least one expandable and retractable band (not shown in this Figure), wherein the linear attachment component is stationarily coupled with the flexible base substrate. Also shown in FIG. 9, a tool and supply storage system 950 is described herein comprising: any one or more of the contemplated removable storage systems 900, and a storage cabinet 960, wherein the storage cabinet comprises at least one attachment point 970 for removably attaching the removable storage system 900.

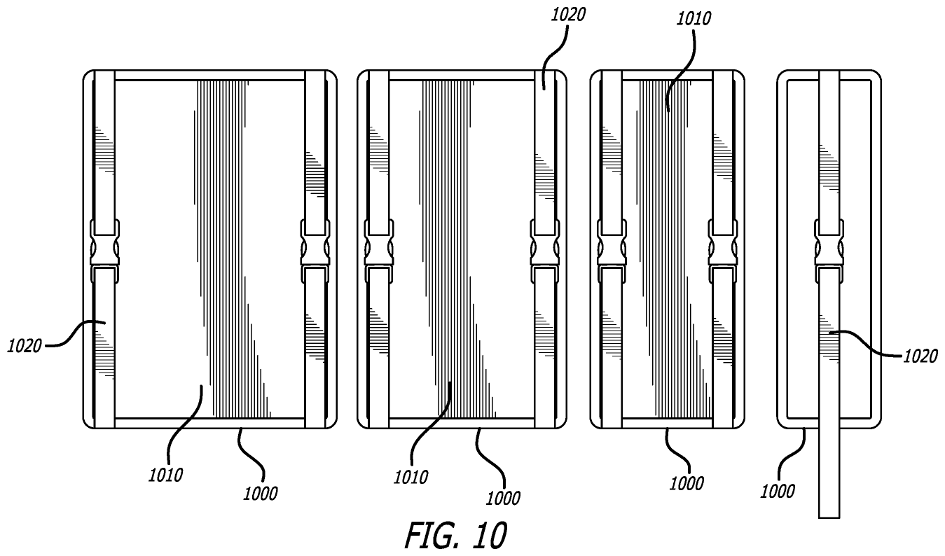

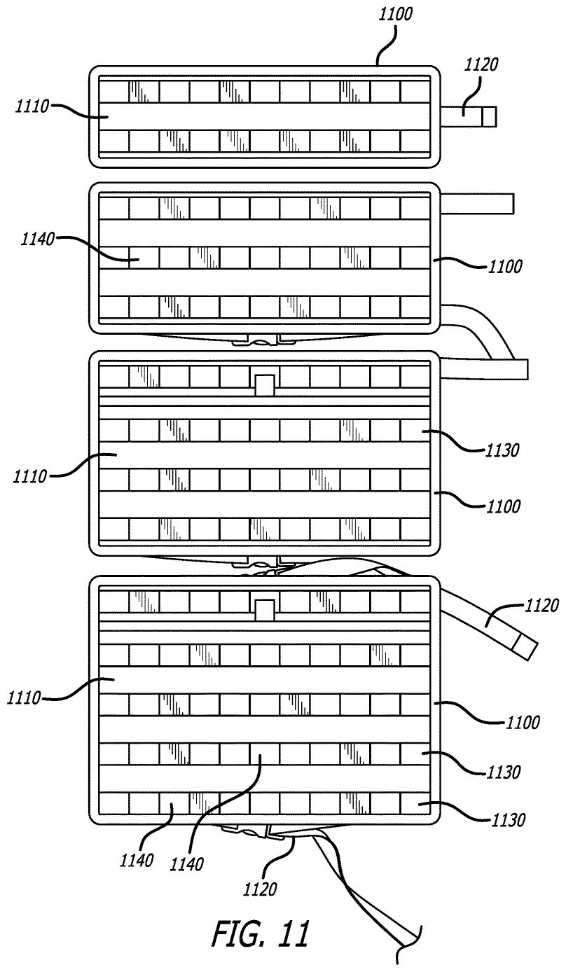

As shown in FIGS. 10 and 11, it should be understood that contemplated embodiments may come in any number of sizes, wherein each size can be removably coupled or attached to the support poles of a storage box or crate. Specifically, FIG. 10 shows a removable storage system 1000 comprising: a flexible base substrate 1010, at least one coupling system 1020 that is secured to the flexible base substrate 1010, wherein the coupling system is designed to be attached to and removed from a separate storage cabinet (not shown in this Figure), and at least one linear attachment component that comprises at least one expandable and retractable band (not shown in this Figure), wherein the linear attachment component is stationarily coupled with the flexible base substrate.

FIG. 11 shows a removable storage system 1100 comprising: a flexible base substrate 1110, at least one coupling system 1120 that is secured to the flexible base substrate, wherein the coupling system is designed to be attached to and removed from a separate storage cabinet (not shown in this Figure), and at least one linear attachment component 1130 that comprises at least one expandable and retractable band 1140, wherein the linear attachment component is stationarily coupled with the flexible base substrate.

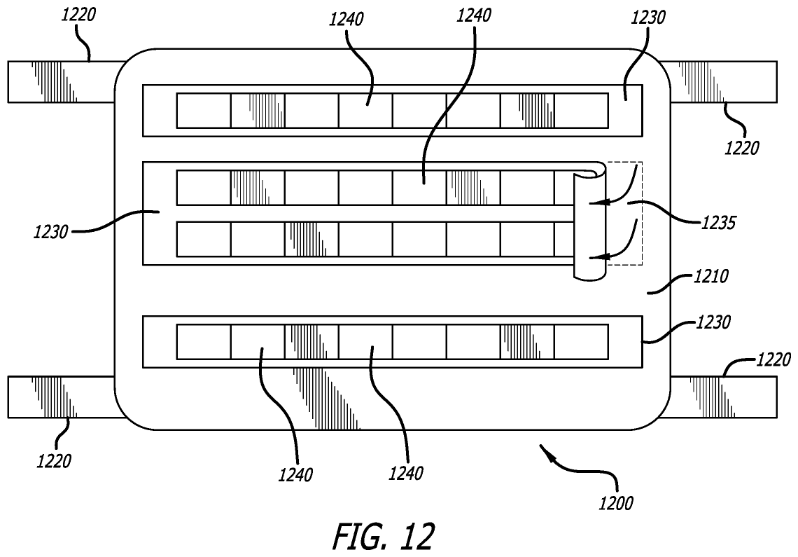

Another contemplated removable storage system 1200 is disclosed herein and shown in FIG. 12, comprising: a flexible base substrate 1210, at least one coupling system 1220 that is secured to the flexible base substrate, wherein the coupling system is designed to be attached to and removed from a separate storage cabinet (not shown in this Figure), and at least one linear attachment component 1230 that comprises at least one expandable and retractable band 1240, wherein the linear attachment component is removably coupled, as shown by reference 1235, with the flexible base substrate 1210. The dotted line at 1235 represents the connection point or layer where the linear attachment component is removably coupled with the flexible base substrate. In this type of embodiment, the surface of the flexible base substrate may comprise a material that is compatible with the backing on the linear attachment component, so that the linear attachment component can be attached or coupled with the flexible base substrate and then removed. A suitable material for this purpose may be VELCRO or a VELCRO-like compatible material.

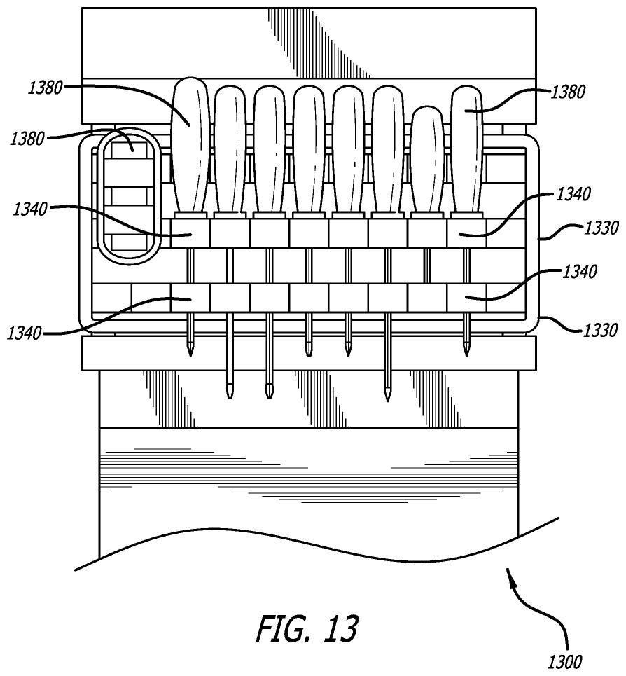

FIG. 13 shows a contemplated removable storage system 1300 that is disclosed herein, wherein at least one tool 1380 is being held in place by the at least one expandable and retractable band 1340 on the at least one linear attachment component 1330. In contemplated embodiments, the storage system is removable from the storage cabinet or box without disrupting the tools/supplies. The tools and supplies are held in place and stabilized by the one or more expandable and retractable bands.

FIG. 14 shows a contemplated removable storage system 1400 that is disclosed herein, wherein at least one tool 1480 is being held in place by the at least one expandable and retractable band 1440 on the at least one linear attachment component 1430. Specifically, at least one tool or supply is slid into and secured by at least one of the at least one expandable and retractable bands. In addition, this figure shows how multiple storage cabinets 1460 can be stacked in contemplated systems, wherein each storage cabinet is capable of having a removable storage system 1400 attached or coupled to it. Also, this figure shows that contemplated removable storage systems 1400 can have pouches or pockets 1405 where additional tools 1480 may be stored for easy storage and retrieval. A contemplated pouch or pocket is designed in a way that there is an opening in the flexible base substrate or two flexible base substrates are coupled together to form the pouch or pocket. The at least one linear attachment component 1430 that comprises at least one expandable and retractable band 1440 is coupled to the outside portion of the flexible base substrate (which forms the outside of the pouch or pocket), as seen in this figure. Also shown in FIG. 14, a tool and supply storage system 1450 is described herein comprising: any one or more of the contemplated removable storage systems 1400, and a storage cabinet 1460, wherein the storage cabinet comprises at least one attachment point 1470 for removably attaching the removable storage system 1400.

Thus, specific embodiments of adaptable and removable attachment and storage systems and their methods of use and production have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A removable storage system, comprising:
a flexible base substrate,
at least one coupling system that is secured to the flexible base substrate, wherein the coupling system is designed to be attached to and removed from a separate storage cabinet, and
at least one linear attachment component that comprises at least one expandable and retractable band, wherein the linear attachment component is stationarily coupled with the flexible base substrate.

2. The removable storage system of claim 1, further comprising at least one tool or supply that is slid into and secured by at least one of the at least one expandable and retractable bands.

3. The removable storage system of claim 2, wherein the storage system is removable without disrupting the tools/supplies.

4. The removable storage system of claim 1, wherein the flexible base substrate comprises a synthetic fabric, a natural fabric, or a combination thereof.

5. The removable storage system of claim 4, wherein the synthetic fabric comprises a polymer.

6. The removable storage system of claim 5, wherein the polymer is nylon.

7. The removable storage system of claim 1, wherein the flexible base substrate comprises at least two layers of material.

8. The removable storage system of claim 7, wherein the flexible base substrate comprises at least three layers of material.

9. The removable storage system of claim 8, wherein at least one layer of material is aluminum.

10. The removable storage system of claim 1, wherein the at least one coupling system comprises at least one male locking component and at least one corresponding female locking component.

11. The removable storage system of claim 1, wherein the at least one coupling system comprises at least one hook and loop-style coupling component.

12. The removable storage system of claim 8, wherein the at least one hook and loop-style coupling component comprises a Velcro-type coupling component.

13. The removable storage system of claim 1, further comprising at least one pocket or pouch.

14. A tool and supply storage system comprising:
the removable storage system of claim 1, and
a storage cabinet, wherein the storage cabinet comprises at least one attachment point for removably attaching the removable storage system.

15. A removable storage system, comprising:
a flexible base substrate,
at least one coupling system that is secured to the flexible base substrate, wherein the coupling system is designed to be attached to and removed from a separate storage cabinet, and
at least one linear attachment component that comprises at least one expandable and retractable band, wherein the linear attachment component is removably coupled with the flexible base substrate.

16. The removable storage system of claim 15, wherein the linear attachment component is removably coupled with the flexible base substrate using a hook and loop style coupling component.
